(19) United States
(12) Patent Application Publication
(10) Pub. No.: US 2001/0017245 A1
(43) Pub. Date: Aug. 30, 2001

(54) Brake cable connector device for connecting brake cable to brake lever in brake device

(75) Inventors: Kazuyasu Komoda, Toyota-shi (JP); Naomi Mitsuoka, Toyota-shi (JP); Tomoki Kakihara, Toyota-shi (JP)

Correspondence Address: OLIFF & BERRIDGE, PLC, 277 S. WASHINGTON STREET, SUITE 500, ALEXANDRIA, VA, 22314, US

(73) Assignee: Hosei Brake Ind. Co., Ltd.

(21) Appl. No.: 09/778,793

(22) Filed: Feb. 8, 2001

(30) Foreign Application Priority Data
Feb. 24, 2000 (JP) 2000-047431
Aug. 15, 2000 (JP) 2000-246290

(51) Int. Cl. F16D 55/08; F16D 55/16

(52) U.S. Cl. 188/72.9

(57) ABSTRACT

A brake cable connector device used for a brake device, and serving for guiding a brake cable into engagement with a brake lever when an end portion of the brake cable is introduced through an opening formed through a backing plate into the interior of the brake device under assembling. The brake cable connector device includes a guide member which is formed separately from the brake lever and which is fixedly attachable to the brake lever. The guide member is configured such that an end of the brake cable is brought into contact with the guide member and guided into engagement with an engaging portion of the brake lever when the end portion of the brake cable is introduced into the interior of the brake device at a predetermined position of the brake device. The brake cable connector device includes a guide pipe which extends through the backing plate so that the brake cable is introduced through the guide pipe into the interior of the brake device. The guide pipe has a radial protrusion which is brought into engagement with an edge portion of the backing plate defining the opening, for limiting a distance over which the guide pipe is introduced into the interior of the brake device.

### BACKGROUND OF THE INVENTION

1. Field of the Invention

The present invention relates in general to a brake device, and more particularly to a brake cable connector device for connecting a brake cable to a brake lever in a brake device.

2. Discussion of the Related Art

There is widely known a brake device of the type wherein a braking force is generated upon a pivotal motion of a brake lever which takes place when a brake cable connected to the brake lever is pulled by an operation of an operator-controlled operating member. A parking brake device of drum brake type for an automotive vehicle is one example of such a brake device. For instance, the parking brake device includes (a) a backing plate in the form of a generally circular disc fixed to the body of the vehicle, (b) a pair of arcuate brake shoes disposed substantially symmetrically with each other along respective circumferential portions of the periphery of the backing plate such that the two brake shoes are movable toward and away from each other, (c) a parking brake lever connected to one of the two brake shoes such that the parking brake lever is pivotable relative to that brake shoe about an axis substantially perpendicular to the plane of the backing plate, (d) a strut which engages the parking brake lever and the other brake shoe, (e) a brake drum rotating with a wheel of the vehicle, and (f) a parking brake cable connected to the parking brake lever so that when the parking brake cable is pulled, the parking brake lever is pivoted radially inwardly of the backing plate, causing the two brake shoes to be moved away from each other via the strut and forced against the inner circumferential surface of the brake drum, whereby a braking force is applied to the vehicle wheel.

In such a brake device as described above, a brake cable connector device for connecting the brake cable to the brake cable includes a J-shaped engaging portion formed integrally with one end portion of the brake lever such that the engaging portion is curved through about 180° with respect to the plane of the brake lever, as disclosed in JP-A-10-220506. The J-shaped engaging portion has an opening through which the end portion of the brake cable extends such that a cable end which is fixed to the end of the brake cable and which is larger than the size of the opening of the J-shaped engaging portion is held in contact with the end face of the engaging portion, whereby the cable is fixed at its end to the lever. The brake cable connector device further includes a guide portion also formed integrally with the brake lever. This guide portion is arranged to guide the end portion of the brake cable into the opening of the J-shaped engaging portion of the brake lever while the end portion of the cable is flexed after it is introduced into the interior of the brake device through an opening formed through the backing plate located on the rear side of the brake device. The guide portion is provided since it is difficult to visually inspect the end portion of the brake cable which has been introduced into the interior of the brake device, which accommodates the brake shoes, brake lever, strut and other components that are assembled together. The guide portion is adapted so that the cable end is guided in sliding contact with the guide portion, until the cable end reaches the opening of the J-shaped engaging portion.

The brake cable connector device further includes a guide pipe which is disposed such that the brake cable is introduced from an exterior of the brake device into the interior of the brake device through the guide pipe whereby the end portion of the brake cable that is difficult to be visually inspected is guided by the guide pipe into engagement with the engaging portion of the brake lever.

The manner of introducing the end portion of the brake cable into the interior of the brake device may differ on different vehicle models. Accordingly, the guide portions integrally formed with the brake levers in the brake devices used on the different vehicle models must have different configurations. In other words, the different vehicle models must use different brake levers, and the application of each brake lever is limited, requiring the manufacture of a relatively large number of different brake levers whose guide portions have different configurations. This requires the use of a large number of die sets for manufacturing the desired brake levers on pressing machines, resulting in an undesired increase in the cost of manufacture of the brake lever. It is also noted that the brake lever is required to have a high mechanical strength and must therefore be made from a metal sheet or plate having a sufficiently large thickness. Accordingly, the required material cost and installation space and the weight of the brake lever tend to be increased. Further, it is difficult to form the guide portion as desired, or difficult to give the guide portion an optimum configuration, since the guide portion formed integrally with the brake lever has the same large thickness as the lever.

The guide pipe extends through the opening formed through the backing plate, and is fixed at one of opposite end portions to the backing plate by welding or other suitable fixing means. The guide pipe has to be accurately positioned in a predetermined position relative to the backing plate upon fixing of the guide pipe to the backing plate, the guide pipe otherwise could not guide the end portion of the brake cable in a direction which permits the end portion of the brake cable to be brought into engagement with the engaging portion of the brake lever. Thus, an operation for fixing the guide pipe to the backing plate is difficult and cumbersome.

### SUMMARY OF THE INVENTION

It is a first object of the present invention to provide a brake cable connector device which has a reduced weight and is economical to manufacture with a desired configuration and which permits the same brake lever configuration to be used in different brake devices in which the end portion of the brake cable is introduced into the interior of the brake devices in different manners.

It is a second object of the present invention to provide a brake cable connector device which has a guide pipe for guiding the brake cable into engagement with the brake lever and which is capable of being accurately and easily positioned in a predetermined position relative to the backing plate.

The above first object may be achieved according to a first aspect of the present invention, which provides a brake cable connector device for a brake device including a brake lever having an engaging portion, and a brake cable which has a cable end fixed at one end thereof and which is connected at the cable end to the engaging portion of the brake lever, and wherein a braking force is generated upon a pivotal movement of the brake lever which takes place when the brake cable is pulled, the brake cable connector device operating to guide the cable end into engagement with the engaging portion of the brake lever when an end portion of the brake cable which has the cable end is introduced into an interior of the brake device upon assembling of the brake device, the brake cable connector device being characterized by comprising a guide member formed separately from the brake lever and fixedly attachable to the brake lever, the guide member being configured such that the cable end is brought into contact with the guide member and guided into engagement with the engaging portion of the brake lever when the end portion of the brake cable is introduced into the interior of the brake device at a predetermined position of the brake device.

In the brake cable connector device of the first aspect of the present invention constructed as described above, the guide member for guiding the cable end into engagement with the engaging portion of the brake lever after the end portion of the brake cable is introduced into the interior of the brake device is formed separately from the brake lever, and so as to be fixedly attachable to the brake lever. Accordingly, the guide member can be formed from a thin sheet or plate having a desired mechanical strength, with a significantly reduced weight, and the required space for installation of the guide member can be made relatively small. Further, the thin sheet can be relatively easily formed into the desired guide member, with a relatively high degree of freedom in its configuration. In other words, the guide member can be given an optimum configuration that permits the cable end to be suitably guided into engagement with the engaging portion of the brake lever, assuring a higher degree of accuracy of assembling of the brake device even where the brake cable is automatically connected to the brake lever, or an increased efficiency of manual connection of the brake cable to the brake lever. In addition, the guide member formed from a thin sheet may be designed to have a desired or optimum configuration or shape which suits the specific manners of introduction of the end portion of the brake cable with the cable end, which manners are different on different models of automotive vehicles on which the brake device is provided. In other words, the same brake lever can be used for the different vehicle models, in combination with the guide members having different configurations. Accordingly, the versatility of the brake lever is improved, without a significant increase in the total cost of manufacture of the brake lever and the guide member. The relatively high degree of freedom in design of the guide member permits the guide member of the same configuration to be commonly used for different configurations of the brake device which involve different manners of introduction of the brake cable into the interior of the brake device. In this respect, too, the cost of manufacture of the brake device can be reduced.

A first preferred form the first aspect of the present invention is suitably applicable to a parking brake device of drum brake type for an automotive vehicle, which parking brake device includes (a) a backing plate in the form of a generally circular disc fixed to the body of the vehicle, (b) a pair of arcuate brake shoes disposed substantially symmetrically with each other along respective circumferential portions of the periphery of the backing plate such that the two brake shoes are movable toward and away from each other, (c) the above-indicated brake lever in the form of a parking brake lever connected to one of the two brake shoes such that the parking brake lever is pivotable relative to that one brake shoe about an axis substantially perpendicular to the plane of the backing plate, (d) a strut which engages the parking brake lever and the other brake shoe, (e) a brake drum rotating with a wheel of the automotive vehicle, and (f) the above-indicated brake cable in the form of a parking brake cable connected to the parking brake lever so that when the parking brake cable is pulled, the parking brake lever is pivoted radially inwardly of the backing plate, causing the two brake shoes to be moved away from each other via the strut and forced against the inner circumferential surface of the brake drum, whereby a braking force is applied to the vehicle wheel. However, the brake cable connector device may be used for other types of brake device for automotive vehicles, and any brake devices adapted to be used for mobile systems or equipment other than automotive vehicles.

The parking brake lever and brake shoe may be pivotally connected to each other by a connecting pin which is substantially perpendicular to the plane of the backing plate. Similarly, the parking brake lever and the strut may be pivotally connected to each other by a connecting pin.

However, the parking brake lever may be held in abutting engagement with the brake shoe or strut, under a biasing action of a spring, and by means of cutouts for relative positioning of the two members relative to each other.

In one advantageous arrangement of the above first preferred form of the first aspect of the invention, the brake cable connector device for the drum brake type parking brake device indicated above further comprises a guide pipe which fixedly extends through the backing plate and which has an inner open end open in the interior of the drum type parking brake device, and wherein the guide member attached to the parking brake lever is configured to guide the cable end into engagement with the engaging portion of the parking brake lever when an end portion of the parking brake cable which has the cable end at the extreme end is introduced into the interior through the guide pipe, while the cable end is advanced generally toward the engaging portion.

According to a second preferred form of the first aspect the present invention, the engaging portion of the brake lever consists of a J-shaped end portion of the brake lever, the J-shaped end portion having a slot through which the end portion of the brake cable extends with the cable end held in engagement with the engaging portion after the cable end has been connected to the J-shaped end portion, the guide member including a guiding portion for guiding the cable end in sliding contact therewith until the cable end has reached and passed an opening of the slot, as the end portion of the brake cable is advanced through the interior of the brake device, while the end portion of the brake cable is flexed by the guiding portion, the guiding portion of the guide member permitting the end portion of the brake cable to be received in the slot through the opening under a resilient force of the brake cable after the cable end has passed the opening.

The J-shaped engaging portion of the brake lever may have a semi-circular part having a predetermined radius of curvature, or a U-shaped part consisting of two opposed side walls and a bottom wall connecting the two opposed side walls substantially at right angles. This also applies to a U-shaped curved portion of the guide member according to a third preferred form of the present invention, which will be described. The cable end to be held in engagement with the engaging portion of the brake lever may take the form of a cylinder or a hexagon prism, for instance. The size of the cable end must be larger than the dimension between the opposed surfaces of the opening of the J-shaped engaging portion, in order to hold the cable end in engagement with the end face of the J-shaped engaging portion while the end portion of the brake cable extends through the opening.

According to one advantageous arrangement of the above second preferred form of the first aspect of the present invention, the guide member includes (a) a U-shaped curved portion having a U shape corresponding to a shape of the slot of the J-shaped end portion of the brake lever, the U-shaped curved portion being fitted in the slot in close contact with an inner surface of the slot, such that the U shape is open toward the opening of the slot, and (b) a positioning portion which engages the brake lever to hold the guide member in a predetermined posture.

Since the guide member according to the above advantageous arrangement has the U-shaped curved portion and the positioning portion, the guide member can be easily and efficiently attached to the brake lever.

The positioning portion of the guide member may include at least one of: a plurality of engaging tabs which engages the brake lever; at least one gripper arm each of which grips the brake lever; and at least one locking pawl which engages a hole formed in the brake lever.

In the above-indicated advantageous arrangement of the above second preferred form of the first aspect of the invention, the U-shaped curved portion of the guide member may include a pair of side walls defining the slot. In this case, the guiding portion of the guide member may include a first guide extending from one of the pair of side walls which is located on the side of a body of the brake lever, and a second guide extending from the other side wall which is on the side of a distal end of the J-shaped end portion of the brake lever. The first guide extends toward the predetermined position of the brake device, so as to guide the cable end to a position right above the opening of the slot. The second guide is adapted to guide the cable end along an end face of the distal end and extend over a predetermined distance from the J-shaped end portion of the brake lever in a direction of introduction of the end portion of the brake cable into the interior of the brake device.

In the above arrangement wherein the first and second guides are formed so as to extend from the respective side walls of the U-shaped curved portion of the guide member, the cable end can be stably guided into engagement with the J-shaped engaging end portion of the brake lever. Since the second guide extends from the J-shaped engaging end portion of the brake lever in the direction of advancement of the end portion of the brake cable, the brake cable is prevented from being removed from the engaging end portion of the brake lever after the cable end is brought into engagement with the engaging end portion with the extreme end of the brake cable extending through the slot of the engaging end portion.

The first guide which extends toward the predetermined position of the brake device from which the end portion of the brake cable is introduced may be a semi-cylindrical, semi-conical or any other curved or bent part of the guide member, which may be U- or V-shaped in cross section, so as to guide the cable end to the position right above the opening of the slot of the J-shaped engaging end portion of the brake lever.

In the above-indicated advantageous arrangement of the above second preferred form of the first aspect of the invention, the U-shaped curved portion of the guide member may be formed from a spring sheet and is held in close contact with the inner surface of the slot of the J-shaped end portion of the brake lever under an elastic force of the spring sheet. In this instance, the U-shaped curved portion may include a pair of side walls defining the slot, and the guide member may further include an engaging projection which extends from one of the side walls and which is held in engagement with an engaging recess formed in the J-shaped end portion of the brake lever, under an elastic force of the spring sheet, so as to prevent the guide member from being removed from the brake lever.

In the above arrangement wherein the engaging projection of the guide member is held in engagement with the engaging recess formed in the brake lever, the guide member is prevented from being removed from the brake lever, so that the guide member is held in the predetermined posture on the J-shaped engaging end portion of the brake lever. However, an engaging recess such as an engaging hole may be provided in the guide member, for engagement with an engaging projection formed on the brake lever, which engagement is maintained by an elastic force of the spring sheet of the guide member.

In the above-indicated first advantageous arrangement of the above second preferred form of the first aspect of the invention, the guide member may further include an integrally formed stop portion for abutting contact with the cable end after the cable end has passed the opening of the slot by more than a predetermined distance in a direction of introduction of the end portion of the brake cable into the interior of the brake device, with the cable end being guided by the guiding portion, the stop portion preventing the cable end from being further advanced after the cable end has passed the opening by the predetermined distance.

In the above arrangement wherein the stop portion is provided as an integral part of the guide member, the advancing movement of the cable end is prevented by this stop portion after the cable end has passed the opening of the slot of the J-shaped engaging end portion of the brake lever by more than the predetermined distance, so that the cable end will not suffer from a contact thereof with any component of the brake device other than the stop member, which contact would cause the actual path of the cable end to deviate from the nominal path, leading to a risk of failure to connect the end portion of the brake cable to the engaging portion of the brake lever. Thus, the stop portion assures stable connection of the end portion of the brake cable to the engaging portion of the brake lever.

According to a third preferred form of the first aspect of the invention, the guide member is formed from a single spring sheet, and is held fixed to the engaging portion of the brake lever under an elastic force of the spring sheet.

In this third preferred form of the invention wherein the guide member is formed from a single spring sheet, the guide member can be easily and economically manufactured by performing press-forming operations, in particular, bending operations on the spring sheet. Since the guide member can be held fixed to the engaging portion of the brake lever under an elastic force of the spring sheet, without using fasteners such as rivets or screws, the guide member can be easily and efficiently attached to the brake lever. Further, since the guide member can be flexed or elastically deformed, an interference of the guide member if any with the other components of the brake device upon pivotal movement of the brake lever would not cause an operational failure or damage of the brake device. Accordingly, the freedom of design of the configuration of the guide member is increased.

The guide member may be formed from any metal sheet or plate other than a spring sheet, or by connecting a plurality of sheet members. Further, the guide member may be formed of a synthetic resin material. The guide member may be fixed to the brake lever by suitable fasteners such as rivets or screws. Fasteners may be used even where the guide member is formed from a spring sheet according to the third preferred form of the invention.

The brake cable connector device may include a sound generating member which generates a sound utilizing a spring or elastic force, when the cable end has been introduced into the brake device by a predetermined distance, as disclosed in JP-A-10-220506 identified in the BACKGROUND OF THE INVENTION. The sound generating member may be separate from the guide member, or an integral part of the guide member where the guide member is formed from a spring sheet. The sound generating member may be adapted to be elastically deformed by engagement with the cable end when the cable end passes the engaging portion of the brake lever, so that a sound is generated when the deformed sound generating member is restored to its original shape, with a collision of the sound generating member with the brake lever or the guide member.

The above second object may be achieved according to a second aspect of the present invention, which provides a brake cable connector device for a brake device including a backing plate fixed to a body of a vehicle, a brake lever disposed on one of opposite sides of the backing plate, and a brake cable connected at an end portion thereof to the brake lever, and wherein a braking force is generated upon a pivotal movement of the brake lever which take places when the brake cable is pulled, the brake cable connector device comprising a guide pipe which extends through an opening formed through the backing plate, such that the brake cable is introduced from the other of the opposite sides of the backing plate to the one of the opposite sides of the backing plate through the guide pipe whereby the end portion of the brake cable is guided toward the brake lever upon assembling of the brake device. This brake cable connector device is characterized in that the guide pipe is introduced through the opening of the backing plate from the other of the opposite sides of the backing plate to the one of the opposite sides of the backing plate, whereby one of opposite end portions of the guide pipe is positioned by the opening in a predetermined position relative to the backing plate, and that the guide pipe has in the one of the opposite end portions a radial protrusion which is brought into engagement with an edge portion of the backing plate defining the opening of the backing plate, for limiting a distance over which the guide pipe is introduced to the one of the opposite sides of the backing plate.

In the brake cable connector device of the second aspect of the present invention constructed as described above, the guide pipe has, in the above-described one of the opposite end portions thereof, the radial protrusion which is brought into engagement with the edge portion of the backing plate defining the opening of the backing plate, serving as a stopper for limiting the distance over which the guide pipe is introduced into the one of the opposite sides of the backing plate, i.e., the interior of the brake device. Owing to the engagement of the radial protrusion of the guide pipe with the edge portion of the backing plate, the guide pipe is easily positioned relative to the backing plate, facilitating an operation for fixing the guide pipe to the backing plate by welding or other fixing means. The radial protrusion may be provided by a portion of the guide pipe which portion is deformed to be protruded outwardly in the radial direction of the guide pipe. Alternatively, the radial protrusion may be provided by a member which is formed independently of the guide pipe and which is then fixedly fitted onto an outer circumferential surface of the guide pipe.

A first preferred form the second aspect of the present invention is suitably applicable to a parking brake device of drum brake type for an automotive vehicle, which parking brake device further includes (a) two arcuate brake shoes disposed substantially symmetrically with each other along respective circumferential portions of a periphery of the backing plate such that the two brake shoes are movable toward and away from each other, (b) a parking brake lever as the brake lever connected to one of the two brake shoes such that the parking brake lever is pivotable relative to the one of the two brake shoes about an axis substantially perpendicular to a plane of the backing plate, (c) a strut which engages the parking brake lever and the other of the two brake shoes, (d) a brake drum rotating with a wheel of the vehicle, and (e) a parking brake cable as the brake cable connected to the parking brake lever so that when the parking brake cable is pulled, the parking brake lever is pivoted radially inwardly of the backing plate, causing the two brake shoes to be moved away from each other via the strut and forced against an inner circumferential surface of the brake drum, whereby the braking force is applied to the vehicle, and wherein the backing plate consists of a generally circular disc. However, the brake cable connector device may be used for other types of brake device for automotive vehicles, and any brake devices adapted to be used for mobile systems or equipment other than automotive vehicles.

The parking brake lever and brake shoe may be pivotally connected to each other by a connecting pin which is substantially perpendicular to the plane of the backing plate. Similarly, the parking brake lever and the strut may be pivotally connected to each other by a connecting pin.

However, the parking brake lever may be held in abutting engagement with the brake shoe or strut, under a biasing action of a spring, and by means of cutouts for relative positioning of the two members relative to each other.

The brake lever may have an engaging end portion which is curved into a J-shaped configuration and to which the end portion of the brake cable is connected. The brake lever may have also a guide member which is formed integrally with the brake lever or separately from the brake lever, whereby the end portion of the brake cable which portion is protruded from the guide pipe is guided by the guide member, into engagement with the engaging end portion of the brake lever. The end portion of the brake cable may have, at the extreme end, a cable end which may take the form of a cylinder or a hexagon prism, for instance. The size of the cable end must be larger than the dimension between the opposed surfaces of the opening of the J-shaped engaging end portion, in order to hold the cable end in engagement with the end face of the J-shaped engaging end portion while the end portion of the brake cable extends through the opening of the J-shaped engaging end portion.

The above second object may be also achieved according to a third aspect of the present invention, which provides a brake cable connector device for a brake device including a backing plate fixed to a body of a vehicle, a brake lever disposed on one of opposite sides of the backing plate, and a brake cable connected at en end portion thereof to the brake lever, and wherein a braking force is generated upon a pivotal movement of the brake lever which take places when the brake cable is pulled, the brake cable connector device comprising a guide pipe which extends through an opening formed through the backing plate, such that the brake cable is introduced from the other of the opposite sides of the backing plate to the one of the opposite sides of the backing plate through the guide pipe whereby the end portion of the brake cable is guided toward the brake lever upon assembling of the brake device. This brake cable connector device is characterized in that one of opposite end portions of the guide pipe is positioned by the opening in a predetermined position relative to the backing plate, and that the brake device further includes a holding member which is fixed to the backing plate and which positions the other of the opposite end portions of the guide pipe in a predetermined position relative to the backing plate such that the other of the opposite end portions of the guide pipe is held between the holding member and the backing plate.

In the brake cable connector device of the third aspect of the present invention constructed as described above, the above-described one of the opposite end portions of the guide pipe is positioned by the opening formed through the backing plate, in a predetermined position relative to the backing plate, while the other of the opposite end portions of the guide pipe is positioned by the holding member integrally fixed to the backing plate, in a predetermined position relative to the backing plate. Thus, the guide pipe is accurately positioned in a predetermined portion of the backing plate and is then easily attached to the predetermined portion of the backing plate, by simply fixing the holding member to the backing plate.

The other of the opposite end portions of the guide pipe is positioned by the holding member which is a component of the brake device, wherein the guide pipe is fixed at the other end portion or the intermediate portion to the backing plate, preferably, by welding or other suitable fixing means. However, it is possible to fix the guide pipe to the backing plate, simply with holding of the guide pipe by and between the holding member and the backing plate, without using welding or other suitable fixing means.

In the brake cable connector device of this third aspect of the present invention, the guide pipe does not have to be necessary introduced through the opening of the backing plate, from the rear side of the backing plate to the front side of the backing plate, namely, from the other of the opposite sides of the backing plate to the one of the opposite sides of the backing plate. That is, this brake cable connector device may be adapted such that the guide pipe can be introduced through the opening of the backing plate, from the front side of the backing plate into the rear side of the backing plate, namely, from the one of the opposite sides of the backing plate to the other of the opposite sides of the backing plate. Also in this case, the guide pipe may have, in the one of the opposite end portions, a radial protrusion which is brought into engagement with an edge portion of the backing plate defining the opening of the backing plate, as in the above-described brake cable connector device of the second aspect of the invention.

In the brake cable connector device of this third aspect of the present invention, in which the other of the opposite end portions of the guide pipe is pressed by the holding member against the backing plate, at least one of the backing plate and the holding member may have an engaging portion which is brought into engagement with the other of the opposite end portions of the guide pipe, for preventing displacement of the guide pipe relative to the backing plate. In this case, the engaging portion may be provided by an engaging hole which is formed in at least one of the backing plate and the holding member, and the guide pipe may have in the other of the opposite end portions at least one engaging projection which is brought into engagement with the engaging hole.

A first preferred form the third aspect of the present invention is suitably applicable to a parking brake device of drum brake type for an automotive vehicle, which parking brake device further includes (a) two arcuate brake shoes disposed substantially symmetrically with each other along respective circumferential portions of a periphery of the backing plate such that the two brake shoes are movable toward and away from each other, (b) a parking brake lever as the brake lever connected to one of the two brake shoes such that the parking brake lever is pivotable relative to the one of the two brake shoes about an axis substantially perpendicular to a plane of the backing plate, (c) a strut which engages the parking brake lever and the other of the two brake shoes, (d) a brake drum rotating with a wheel of the vehicle, and (e) a parking brake cable as the brake cable connected to the parking brake lever so that when the parking brake cable is pulled, the parking brake lever is pivoted radially inwardly of the backing plate, causing the two brake shoes to be moved away from each other via the strut and forced against an inner circumferential surface of the brake drum, whereby the braking force is applied to the vehicle, and wherein the backing plate consists of a generally circular disc. However, the brake cable connector device may be used for other types of brake device for automotive vehicles, and any brake devices adapted to be used for mobile systems or equipment other than automotive vehicles.

According to a second preferred form of the third aspect of the invention, the guide pipe is introduced through the opening of the backing plate from the other of the opposite sides of the backing plate to the one of the opposite sides of the backing plate, whereby the one of the opposite end portions of the pipe is positioned by the opening in the predetermined position relative to the backing plate; wherein at least one of the backing plate and the holding member has an engaging portion which is brought into engagement with the other of the opposite end portions of the guide pipe, for preventing displacement of the other of the opposite end portions of the guide pipe relative to the backing plate at least in a longitudinal direction of the guide pipe toward the other of the opposite sides of the backing plate away from the one of the opposite sides of the backing plate; and wherein the guide pipe has in the one of the opposite end portions a radial protrusion which is brought into engagement with an edge portion of the backing plate defining the opening of the backing plate, for limiting a distance over which the guide pipe is introduced to the one of the opposite sides of the backing plate while permitting the engaging portion to engage the other of the opposite end portions of the guide pipe.

In the brake cable connector device of this second preferred form of the third aspect of the present invention, the above-described one of the opposite end portions of the guide pipe is positioned by the opening formed through the backing plate, in a predetermined position relative to the backing plate, while the other of the opposite end portions of the guide pipe is positioned by the holding member integrally fixed to the backing plate, in a predetermined position relative to the backing plate. Thus, the guide pipe is accurately positioned in a predetermined portion of the backing plate and is then easily attached to the predetermined portion of the backing plate, by simply fixing the holding member to the backing plate.

In addition, the engagement of the engaging portion provided in at least one of the backing plate and the holding member prevents displacement of the guide pipe relative to the backing plate at least in a longitudinal direction of the guide pipe toward the other of the opposite sides of the backing plate away from the one of the opposite sides of the backing plate, and the engagement of the radial protrusion of the guide pipe with the edge portion of the backing plate limits the distance over which the guide pipe is introduced to the one of the opposite sides of the backing plate while permitting the engaging portion to engage the other of the opposite end portions of the guide pipe. Thus, the guide pipe is more accurately positioned in a predetermined portion of the backing plate and is then more easily attached to the predetermined portion of the backing plate, by simply fixing the holding member to the backing plate. The radial protrusion may be provided by a portion of the guide pipe which portion is deformed to be protruded outwardly in the radial direction of the guide pipe. Alternatively, the radial protrusion may be provided by a member which is formed independently of the guide pipe and which is then fixedly fitted onto an outer circumferential surface of the guide pipe.

The other of the opposite end portions of the guide pipe is positioned by the holding member which is a component of the brake device, wherein the guide pipe is fixed at the other end portion or the intermediate portion to the backing plate, preferably, by welding or other suitable fixing means. However, it is possible to fix the guide pipe to the backing plate, simply with holding of the guide pipe by and between the holding member and the backing plate, without using welding or other suitable fixing means.

According to an advantageous arrangement of the second preferred form of the third aspect of the invention, the brake device further includes brake shoes, an anchor and an anchor plate which is fixed together with the anchor to the backing plate and which positions the brake shoes relative to the backing plate; wherein the holding member consists of the anchor plate, and has a pipe holding portion which has a curved surface fitted on an outer circumferential surface of the guide pipe and positions the other of the opposite end portions of the guide pipe in the predetermined position relative to the backing plate such that the other of the opposite end portions of the guide pipe is held between the holding member and the backing plate; and wherein the engaging portion is provided by an engaging hole which is formed in the above-described at least one of the backing plate and the holding member, and the guide pipe has in the other of the opposite end portions at least one engaging projection which is brought into engagement with the engaging hole, for preventing displacement of the other of the opposite end portions of the guide pipe in a direction substantially parallel to a plane of the backing plate.

In the brake cable connector device of this advantageous arrangement of the second preferred form of the third aspect of the present invention, the other of the opposite end portions of the guide pipe is positioned by the pipe holding portion of the holding member having the curved surface which is fitted on the outer circumferential surface of the guide pipe, while the engaging projection provided in the guide pipe is brought into engagement with the engaging hole formed in at least one of the backing plate and the holding member, so that the other of the opposite end portions of the guide pipe is more accurately positioned in the predetermined position relative to the backing plate and is held in a predetermined posture relative the backing plate, thereby making it possible to more reliably guide the brake cable toward an engaging portion of the brake lever to which portion the brake cable is to be connected. The other of the opposite end portions of the guide pipe is positioned by the holding member which is a component of the brake device, wherein the guide pipe is fixed at the other end portion or the intermediate portion to the backing plate, preferably, by welding or other suitable fixing means. However, it is possible to fix the guide pipe to the backing plate, simply with holding of the guide pipe by and between the holding member and the backing plate, without using welding or other suitable fixing means.

In the brake cable connector device of this advantageous arrangement, the engaging projection provided in the guide pipe is brought into engagement with the engaging hole formed in at least one of the backing plate and the holding member. However, the engaging projection may adapted to be brought into engagement with an end face of the holding member. In this sense, the engaging hole is not essential. Further, the engaging hole may be replaced by an engaging recess formed in at least one of the backing plate and the holding member, so that the engaging projection is brought into engagement with the engaging recess. Still further, the engaging hole or recess may be formed in the guide pipe, while the engaging projection may be provided in at least one of the backing plate and the holding member.

In the brake cable connector device of this advantageous arrangement, the pipe holding portion of the holding member has a curved surface which is fitted on the outer circumferential surface of the guide pipe. However, the pipe holding portion may have a flat surface which is substantially parallel to the backing plate, a V-shaped surface which is bent to be convexed in a direction away from the backing plate, or other surface having a suitable cross section shape which is determined depending upon, for example, a cross sectional shape of the guide pipe.

### BRIEF DESCRIPTION OF THE DRAWINGS

The above and other objects, features, features, advantages and technical and industrial significance of this invention will be better understood by reading the following detailed description of presently preferred embodiments of the invention, when considered in connection with the accompanying drawings, in which:

FIG. 1 is a front elevational view of a drum brake constructed according to a first embodiment of this invention;

FIG. 2 is a cross sectional view taken along line 2-2 of FIG. 1;

FIG. 3 is a rear elevational view of a parking brake cable connector device provided in the drum brake of FIG. 1;

FIG. 4A is a front elevational view of a guide member attached to a parking brake lever in the drum brake of FIG. 1;

FIG. 4B is a right-hand side elevational view of the guide member;

FIG. 4C is a cross sectional view taken along line C-C of FIG. 4A;

FIG. 5 is a front elevational view of a drum brake constructed according to a second embodiment of this invention;

FIG. 6A is a cross sectional view taken along line 6A-6A of FIG. 5;

FIG. 6B is a cross sectional view taken along line 6B-6B of FIG. 6A; and

FIG. 7 is a view corresponding to that of FIG. 6A, showing a part of one modification of the drum brake of FIG. 5, in which a radial protrusion of the guide pipe is different from the radial protrusion of the guide pipe of FIG. 5.

### DETAILED DESCRIPTION OF THE PREFERRED EMBODIMENTS

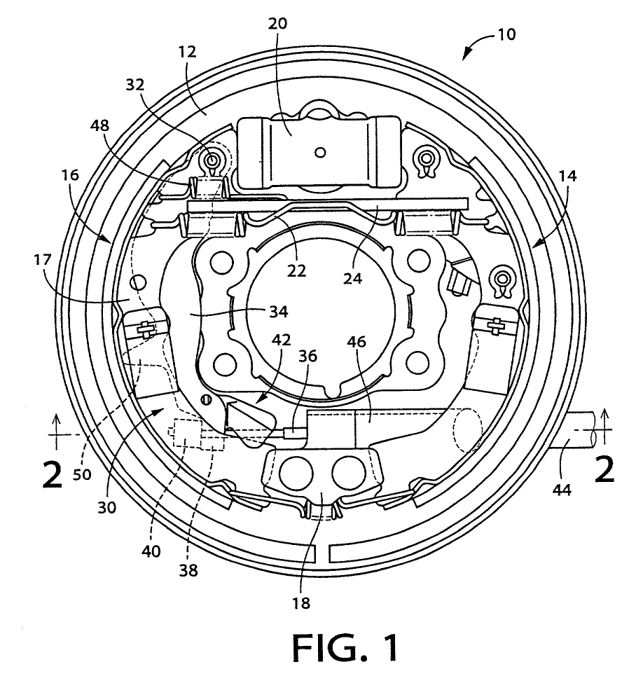

Referring first to the front elevational view of FIG. 1, there is shown a drum brake 10 of leading/trailing type for use on an automotive vehicle. This drum brake 10 includes a backing plate 12 in the form of a generally circular disc fixedly disposed on the body of the vehicle, and a pair of arcuate brake shoes 14, 16 disposed substantially symmetrically with each other along respective circumferential portions of the periphery of the backing plate 12 such that the two brake shoes 14, 16 are movable toward and away from each other. The drum brake 10 further includes an anchor 18 fixedly interposed between the lower ends of the two brake shoes 14, 16, and a wheel brake cylinder 20 interposed between the upper ends of the two brake shoes 14, 16.

The wheel brake cylinder 20 has a pair of pistons and a pair of piston rods extending from the pistons. When a fluid pressure is applied to the pistons, the piston rods move the upper ends of the respective brake shoes 14, 16 in opposite directions away from each other, so that the brake shoes 14, 16 are forced against the inner circumferential surface of a brake drum which rotates with a vehicle wheel, whereby the drum brake 10 produces a braking force for braking the vehicle wheel. A return spring 22 and a strut 24 are associated with the upper ends of the two brake shoes 14, 16. When the pressurized fluid is discharged from the wheel brake cylinder 20, the brake shoes 14, 16 are moved toward each other under a biasing action of the return spring 22, to their non-operated or original position which is determined by the strut 24.

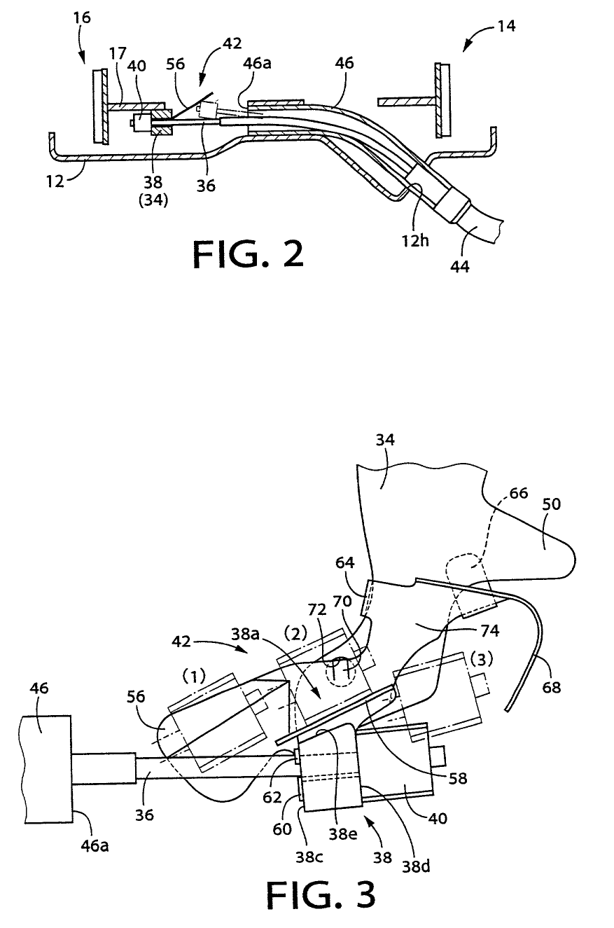

The drum brake 10 further includes a parking brake mechanism 30, which is a brake device constructed according to the present invention. The parking brake mechanism 30 includes a parking brake lever 34 which is connected to the upper end portion of the brake shoe 16 through a connecting pin 32 extending substantially perpendicularly to the plane of the backing plate 12, such that the parking brake lever 34 is pivotable relative to the brake shoe 16 about the connecting pin 32. The parking brake mechanism 30 further includes a parking brake cable 36 connected to the parking brake lever 34. The parking brake lever 34 is interposed in the axial direction of the drum brake 10, between the backing plate 12 and a web 17 of the brake shoe 16, as shown in the cross sectional view of FIG. 2 taken along line 2-2 of FIG. 1, such that the parking brake lever 34 extends in the vertical direction as viewed in FIG. 1.

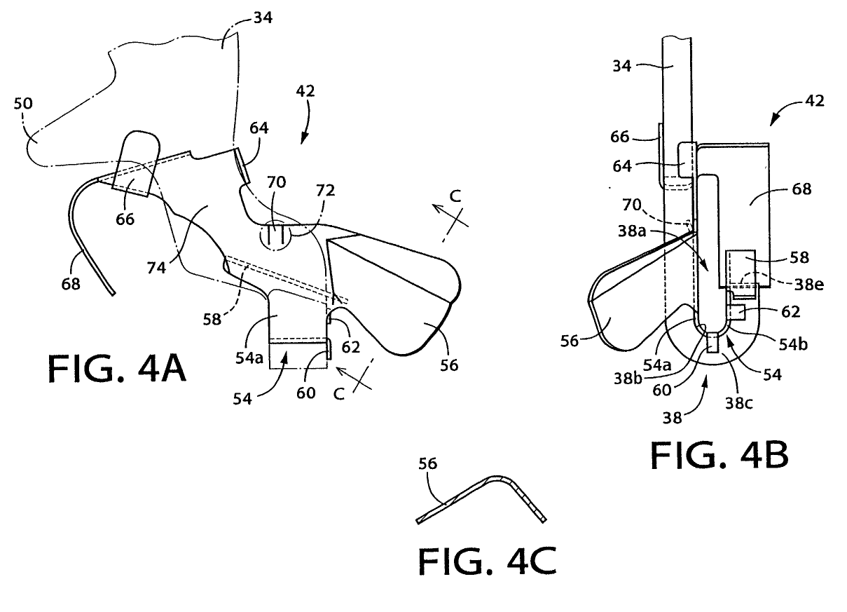

As shown in FIG. 4B, the parking brake lever 34 has an engaging portion 38 formed integrally with its lower end portion such that the engaging portion 38 is curved into a J-shaped configuration. The parking brake cable 36 has a cable end 40 at its end on the side of the drum brake 10. As shown in FIGS. 1-3 and 4B, the parking brake cable 36 is fixed at the above-indicated end to the engaging portion 38 of the parking brake lever 34, with the cable end 40 held in contact with the end face of the engaging portion 38. FIG. 3 is a rear view showing the lower end portion of the parking brake lever 34 with the engaging portion 38 and the end portion of the parking brake cable 36 with the cable end 40. The rear view of FIG. 3 is taken in the direction from the backing plate 12 toward the web 17 of the brake shoe 16. It is noted that the parking brake cable 36 is not shown in the side elevational view of FIG. 4B. As shown in FIG. 4B, the J-shaped engaging portion 38 has a semi-circular or 180° arcuate part having a suitable radius of curvature, and is formed such that the engaging portion 38 has a distal end 38e located on the side of the backing plate 12. To the engaging portion 38 of the parking brake lever 34 (of the parking brake mechanism 30), there is attached a guide member 42, which will be described in detail.

The cable end 40 takes the form of a cylinder or a hexagon prism coaxially fixed to the end of the cable 36. The cable 36 is connected at the other end to an operator's controlled parking brake operating member such as a parking brake operating lever or pedal. The cable 36 is accommodated in an outer casing 44, and the end portion of the cable 36 extends through a guide pipe 46 fixed to the backing plate 12, as shown in FIG. 2. The guide pipe 46 is a curved tube which extends through an opening 12h formed through the backing plate 12 such that an inner end portion corresponding to the end portion of the cable 36 is located in the housing of the drum brake 10, while the other or outer end portion of the cable 36 is located outside the housing and is connected to the end of the outer casing 44. The extreme end portion with the cable end 40 extends from the inner end of the guide tube 46, and the cable end 40 is held in engagement with the engaging portion 38 of the parking brake lever 34. The position and the direction of extension (indicated by one-dot chain line in FIG. 2) of the extreme end portion of the cable 36 within the housing of the drum brake 10 when the cable end 40 is spaced a small distance from the inner open end 46a of the guide pipe 46 are determined by the position and the configuration of the guide pipe 46.

The strut 24 engages a portion of the parking brake lever 34, which is relatively close to the connecting pin 32. When the parking brake cable 36 is pulled in the right direction as seen in FIG. 1 by an operation of the operator's controlled parking brake operating member, the parking brake lever 34 is pivoted about the pin 32 in the counterclockwise direction as seen in FIG. 1, namely, in the radially inward direction of the backing plate 12, so that the right brake shoe 14 is moved in the right direction through the strut 24. With a resulting reaction force, the left brake shoe 16 is moved in the left or radially outward direction, together with the connecting pin 32. Thus, the two brake shoes 14, 16 are forced against the inner circumferential surface of the brake drum, with a result of generation of a braking force applied to the vehicle wheel. The strut 24 and the parking brake lever 34 have cutouts for relative positioning thereof. A tensile coil spring 48 is connected between the strut 24 and the brake shoe 16, for holding the strut 24 and the parking brake lever 34 in their engaged position. When the parking brake (mechanism 30) is not in operation, the parking brake lever 34 is held in its original or non-operated position under the biasing action of the tensile coil spring 48. In the original position, a protrusion 50 formed on the lever 34 is held in abutting contact with the inner surface of the rim of the left brake shoe 16, as indicated in FIG. 1.

The guide member 42 is provided to guide the cable end 40 of the parking brake cable 36 into engagement with the engaging portion 38 of the parking brake lever 34, when the end portion of the cable 36 with the cable end 40 at its extreme end is introduced into the interior of the drum brake 10 through the guide pipe 46, upon assembling of the parking brake mechanism 30. The cable end 40 is guided by sliding contact with the guide member 42, as indicated by one-dot chain line in FIG. 2. FIG. 4A showing the guide member 42 in detail is a front elevational view corresponding to that of FIG. 1, and FIG. 4B is the side elevational view, while FIG. 4C is a cross sectional view of a first guide 46 taken along line C-C of FIG. 4A.

The guide member 42 is formed from a single spring sheet into a suitable shape, primarily by a bending operation on a press. The guide member 42 can be easily attached to the engaging portion 38 of the lever 34 with a single action, and held in place with an elastic force of the spring sheet. The guide member 42 includes a U-shaped curved portion 54, a first guide 56, a second guide 58, engaging tabs 60, 62, 64, a gripper arm 66, and a stop portion 68.

The U-shaped curved portion 54 has a semi-circular or 180°-arcuate part having a radius of curvature corresponding to that of the semi-circular part of the J-shaped engaging portion 38. The U-shaped curved portion 54 is fitted in the J-shaped engaging portion 38, in close contact with the inner surfaces of the engaging portion 38 which define a slot 38b that is open at 38a in the upward direction as seen in FIG. 4B. This fitting can be achieved by moving down the U-shaped curved portion 54 into the above-indicated slot through the opening 38a, and the U-shaped curved portion 54 is held pressed against the inner surfaces of the J-shaped engaging portion 38 under the elastic force of the spring sheet of the guide member 42.

The U-shaped curved portion 54 has a pair of opposed side walls 54a, 54b connected to each other by the above-indicated semi-circular part. The left side wall 54a (as seen in FIG. 4B) which is located on the side of the body of the parking brake lever 34 has a locking pawl 70 at an upper part thereof, as shown in FIGS. 3, 4A and 4B. The locking pawl 70 is a portion of the left side wall 54a which is bent obliquely outwardly away from the opening 38a of the engaging portion 38. The locking pawl 70 is held in engagement with an engaging hole 72 formed in the engaging portion 38. The elastic force of the spring sheet of the guide member 42 prevents removal of the locking pawls 70 from the engaging holes 70 in the direction toward the opening 38a. The locking pawl 70 serves as a positioning portion for positioning the guide member 42 relative to the parking brake lever 34, and also serve as an engaging projection which engages an engaging recess in the form of the engaging holes 72, for preventing the removal of the guide member 42 from the parking brake lever 34.

The engaging tab 60 is a portion of the above-indicated semi-circular part of the U-shaped curved portion 54, which portion is bent outwardly substantially at right angles. The engaging tab 60 is held in engagement with a left end face 38c (as seen in FIG. 3) of the engaging portion 38, as shown in FIGS. 3 and 4B. The engaging tab 62 is a portion of the right side wall 54b (as seen in FIG. 4B) of the U-shaped curved portion 54, which portion is bent outwardly substantially at right angles. The engaging tab 62 is held in engagement with the left end face 38c of the engaging portion 38, as also shown in FIGS. 3 and 4B. The engaging tab 64 is a portion of an extension 74 extending from the left side wall 54a of the U-shaped curved portion 54 in the direction parallel to the plane of the parking brake lever 34. The above-indicated portion 64 of the extension 74 is bent substantially at right angles, toward the body of the lever 34. The engaging tab 64 is held in engagement with the end face of the lever 34, as shown in FIG. 4A.

The gripper arm 66 is a portion of the extension 74 which is remote from the engaging tab 64, which portion is bent into a U shape so as to grip the lever 34 in the direction of its thickness. The engaging tabs 60, 62, 64 and the gripper arm 66 cooperate with the locking pawl 70 to serve as the positioning member for positioning the guide member 42 relative to the engaging portion 38 of the lever 34. As indicated above, the engaging pawl 70 and the engaging holes 72 function to lock the guide member 42 in position on the lever 34. The dimension of the U-shaped curved portion 54 of the guide member 42 in the right and left direction as seen in FIGS. 3 and 4A is the same as or slightly smaller than that of the J-shaped engaging portion 38. Owing to this dimensioning and the engagement of the engaging tabs 60, 62 with one of the opposite end faces 38c, 38d of the engaging portion 38, the cable end 40 can be suitably brought into engagement with the other end face 38d of the engaging portion 38, as shown in FIG. 3, even in the presence of the guide member 42 attached to the parking brake lever 34.

The first and second guides 56, 58 serve as a guiding portion for guiding the cable end 40 in sliding contact therewith so that the extreme end portion of the parking brake cable 46 is finally brought into the slot 38b of the J-shaped engaging portion 38 of the parking brake lever 34 through the opening 38a, with the cable end 40 being brought into engagement with the end face 38d of the engaging portion 38, when the end portion of the cable 36 is introduced from the outside into the interior of the drum brake 10 through the guide pipe 46. Described more specifically, the cable end 40 of the end portion of the cable 36 first comes into abutting contact with the first guide 56, when the cable end 40 has projected from the inner open end 46a (FIGS. 2 and 3) of the guide pipe 46 by a predetermined distance toward the guide member 42. Then, the cable end 40 is guided in sliding contact with the guiding portion 56, 58 as the end portion of the cable 36 is further moved in the direction toward the engaging portion 38. As the cable 36 is moved toward the engaging portion 38 and is further moved away from the engaging portion 38, the end portion of the cable 36 is flexed in sliding contact with the guiding portion 56, 58 in the right direction toward the backing plate 12 as viewed in FIG. 4B and in the upward direction as seen in FIGS. 3 and 4B. The cable end 40 is thus guided to reach the opening 38a of the engaging portion 38 and pass over the opening 38a to a position right above the distal end 38e of the engaging portion. The extreme end portion of the cable 36 whose cable end 40 has passed over the opening 38a in the right direction as seen in FIG. 4B is permitted to be finally received into the slot 38b of the engaging portion 38 through the opening 38a under a resilient or elastic force of the cable 36 which acts in the left and downward directions as seen in FIG. 4B, so as to restore the cable 36 to its original straight posture extending from the inner open end 46a of the guide pipe 46.

Described in detail, the first guide 56 extends straight from the first or left side wall 54a of the U-shaped curved portion 54 at a given angle with respect to the side wall 54a such that the spacing between the inner surface of the backing plate 12 and the first guide 56 in the axial direction of the drum brake 10 increases as the first guide 56 extends toward the inner open end 46a of the guide pipe 46, as indicated in FIG. 2. The first guide 56 is generally V-shaped in cross section taken along line C-C of FIG. 4A, as shown in FIG. 4C. The first guide 56 is designed to guide the cable end 40 to a position right above the opening 38a of the engaging portion 38. The end portion of the cable 36 guided by the guide pipe 46 extends from its inner open end 46a obliquely with respect to the backing plate 12, while maintaining a straight posture, as indicated by one-dot chain line in FIG. 2, such that the spacing between the straight line of the end portion of the cable 36 and the backing plate 12 in the axial direction of the drum brake 10 increases as the end portion of the cable 36 extends toward the first guide 56. Further, the end portion of the cable 36 extends from the inner open end 46a in the horizontal direction as seen in FIGS. 1 and 3, namely, in the direction perpendicular to the plane of FIG. 4B. When the cable end 40 of the cable 36 has moved from the inner open end 46a of the guide pipe 46 by a predetermined distance, the cable end 40 comes into abutting contact with the first guide 56, and the end portion of the cable 36 is guided to the position right above the opening 38a by the first guide 56 in sliding contact therewith, as indicated at (1) in FIG. 3, while being flexed in the right and upward directions as seen in FIG. 4B. As the cable 36 is further moved with its end portion being guided by the first guide 56, the cable end 40 is brought into sliding contact with the second guide 58, as indicated at (2) in FIG. 3. With the elastic force of the end portion of the cable 36 acting on the first guide 56, the cable end 40 is suitably guided onto the second guide 58, without removal from the first guide 56.

The second guide 58 is formed as an extension from the second or right side wall 54b of the U-shaped curved portion 54 of the guide member 42. The above-indicated extension serving as the second guide 58 is bent outwardly substantially at right angles with respect to the right side wall 54b, so that the second guide 58 extends along the end face 38e of the engaging portion 38, and so that the cable end 40 is guided by the second guide 58 in sliding contact therewith, in the obliquely upward direction along the end face 38e, as indicated in FIG. 3. When the trailing end of the cable end 40 has passed the second guide 58 in the right direction as seen in FIG. 3, the extreme end portion of the cable 36 is inserted into the slot 38b of the J-shaped engaging portion 38 through the opening 38a, by the resilient force of the cable 40 which causes the end portion of the cable 36 to be displaced together with the cable end 40, in the left and downward directions as seen in FIG. 4B, as indicated at (3) in FIG. 3. When the cable 36 is then pulled in the left direction as seen in FIG. 3, the cable end 40 is brought into abutting contact with the end face 38d of the engaging portion 38, as indicated by solid lines in FIG. 3.

The second guide 58 projects suitable distances from the respective opposite end faces of the engaging portion 38 in the opposite directions toward and away from the inner open end 46a of the guide pipe 46, that is, in the right and left directions as seen in FIG. 3, so that the cable end 40 in engagement with the right end face 38d of the engaging portion 38 (as seen in FIG. 3) as indicated by the solid lines in FIG. 3 is prevented from being removed from the engaging portion 38 even when the cable 36 is slackened for some reason or other.

The stopper portion 68 is provided for abutting contact with the cable end 40, to prevent the cable end 40 from being advanced from the second guide 58 by more than a predetermined distance in the right direction as seen in FIG. 3. The stopper portion 68 is formed integrally with the extension 74 indicated above, such that the stopper portion 68 is spaced a predetermined distance from the second guide 58 in the direction of advancement of the cable end 40. In the absence of the stop portion 68, the cable end 40 may contact the brake shoe 16 and the other components, and the end portion of the cable 36 may deviate from a nominal path of advancement which leads to the position right above the distal end 38e, resulting in a risk of failure to connect the end portion of the cable 36 to the engaging portion 38 of the lever 34. To prevent this drawback, the stop portion 68 is provided to block the cable end 40 when the end portion of the cable 36 is advanced more than the predetermined distance from the second guide 58, so that the cable end 40 can be suitably connected to the engaging portion 38.

Thus, the drum brake 10 which has been described above incorporates a brake cable connector device according to the present invention, which includes the guide member 42 and the guide pipe 46.

It will be understood from the foregoing description of the present first embodiment that the guide member 42 for guiding the cable end 40 into engagement with the engaging portion 38 after the end portion of the cable 36 is introduced into the interior of the drum brake 10 through the guide pipe 46 is formed separately from the parking brake lever 34 and is attached to the lever 34. Accordingly, the guide member 42 can be formed from a thin metal sheet having a desired mechanical strength, with a significantly reduced weight, and the required space for installation of the guide member 42 can be made relatively small.

Further, the thin metal sheet can be relatively easily formed into the desired guide member 42, with a relatively high degree of freedom in its configuration. In other words, the guide member 42 can be given an optimum configuration that permits the cable end 40 to be suitably guided into engagement with the engaging portion 38, assuring a higher degree of accuracy of assembling of the drum brake 10 even where the parking brake cable 36 is automatically connected to the lever 34, or an increased efficiency of manual connection of the cable 36 to the lever 34.

Described in detail, the guide member 42 used in the brake cable connector device according to the present first embodiment of the invention is provided with the first and second guides 56, 58 formed so as to extend from the two side walls 54a, 54b of the U-shaped curved portion 54, so that the two guides 56, 58 guide the cable end 40 of the introduced end portion of the cable 36 into engagement with the end face 38d of the J-shaped engaging portion 38 of the parking brake lever 34. Further, the second guide 58 extends a suitable distance from the end face 38d of the engaging portion 38 in the right direction as seen in FIG. 3, namely, in the direction opposite to the direction in which the cable 36 is pulled to activate the parking brake mechanism 30. This arrangement of the second guide 58 is effective to prevent the removal of the cable end 40 from the engaging portion 38 due to slackening of the cable 36 or the like after the extreme end portion of the cable 36 has been received in the slot 38b of the J-shaped engaging portion 38 through the opening 38a with the cable end 40 in contact with the end face 38d of the engaging portion 38.

In addition, the stop portion 68 formed integrally with the guide member 42 prevents an advancement of the cable end 40 by more than the predetermined distance from the second guide 58, so that the cable end 40 is prevented from contacting the brake shoe 16 or other components and deviating from the nominal path of advancement. The stop portion 68 assures appropriate connection of the cable end 40 to the engaging portion 38 with improved stability.

It is also noted that the guide member 42 formed from a thin metal sheet may be designed to have a desired or optimum configuration or shape which suits the specific manners of introduction of the end portion of the cable 36 with the cable end 40, which are different on different vehicle models. In other words, the same parking brake lever 34 can be used for the different vehicle models, in combination with the guide members 42 having different configurations. Accordingly, the versatility of the parking brake lever 34 is improved, without a significant increase in the total cost of manufacture of the lever 34 and the guide member 42. The relatively high degree of freedom in design of the guide member 42 permits the guide member 42 of the same configuration to be commonly used for different configurations of the parking brake mechanism 30 which involve respective different manners of introduction of the parking brake cable 36. In this respect, too, the cost of manufacture of the parking brake mechanism 30 can be reduced.

Furthermore, the present brake cable connector device utilizes the flexible and resilient or elastic properties of the parking brake cable 36 for holding the cable end 40 in engagement with the engaging portion 38, permitting the guide member 42 to be comparatively simple in construction.

In addition, the guide member 42 includes the integrally formed U-shaped curved portion 54 and the integrally formed positioning portion in the form of the engaging tabs 60, 62, 64, gripper arm 66 and locking pawls 70, so that the guide member 42 can be easily and efficiently positioned relative to the parking brake lever 34. In particular, the guide member 42 formed from a spring metal sheet can be attached to the engaging portion 38 with a single action, with more ease and higher efficiency than where the guide member is attached using fastening means such as rivets and screws.

Further, the guide member 42 can be relatively easily and economically produced by performing press-forming operations, in particular, bending operations on a single spring sheet. Since the guide member 42 can be flexed or elastically deformed, an interference of the guide member 42 if any with the other components of the drum brake 10 upon pivotal movement of the parking brake lever 34 would not cause an operational failure or damage of the drum brake 10. For instance, the first guide 56 for guiding the cable end 40 may be easily flexed in the event of an interference with the other components upon operation of the parking brake mechanism 30 involving the pivotal movement of the lever 34. Accordingly, the freedom of design of the configuration of the guide member 42 is further increased.

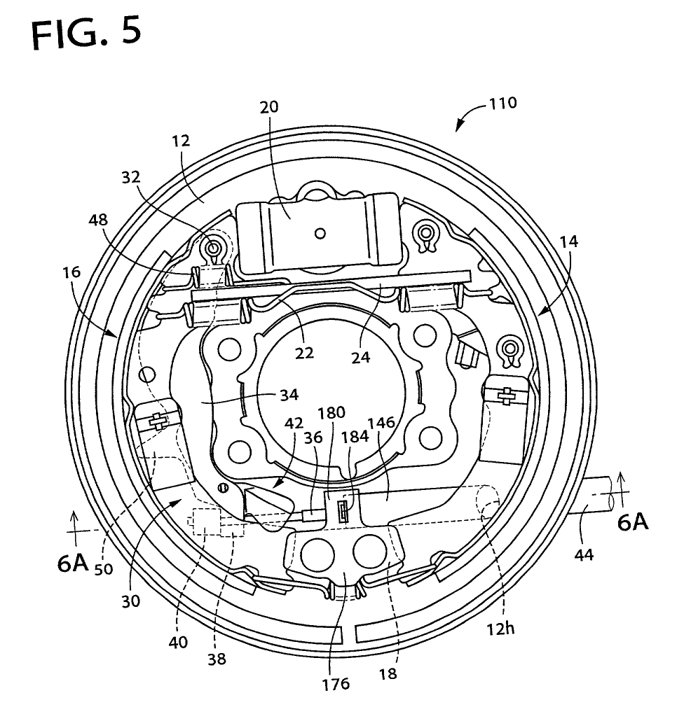

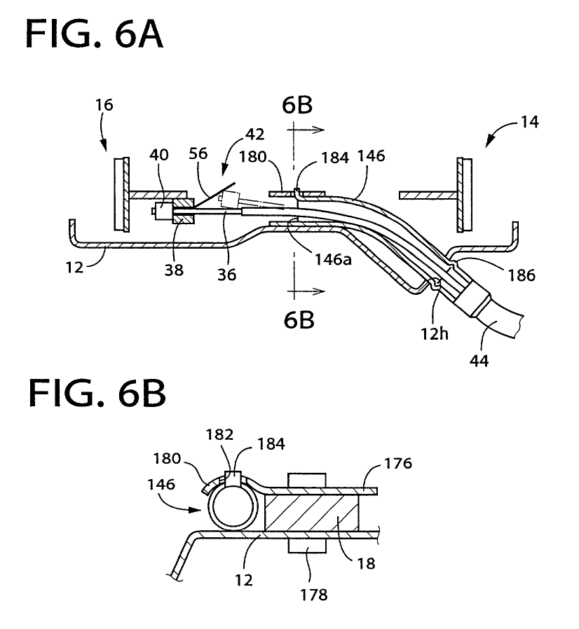

Referring next to FIGS. 5-7, there will be described a drum brake 110 constructed according to a second embodiment of this invention. Since most of the elements used in the second embodiment are similar to those of the first embodiment, the same reference signs as used in the first embodiment will be used in the second embodiment to identify the similar elements, and only such features that are characteristic of the second embodiment will be explained in contrast with the first embodiment. FIG. 5 is a front elevational view of the drum brake 110 of the second embodiment of the invention. FIG. 6A is a cross sectional view taken along line 6A-6A of FIG. 5. FIG. 6B is a cross sectional view taken along line 6B-6B of FIG. 6A.

The drum brake 110 incorporates a brake connector device including the guide member 42 and a guide pipe 146 which is different from the guide pipe 46 of the brake connector incorporated in the drum brake 10 of the first embodiment.

As is apparent from FIGS. 6A and 6B, one of longitudinally opposite end portions of the guide pipe 146 is positioned by the opening 12h relative to the backing plate 12, while the other of the longitudinally opposite end portions of the guide pipe 146 is positioned by a holding member in the form of an anchor plate 176 relative to the backing plate 12. The anchor plate 176 is a component of the drum brake 110, and is fixed together with the anchor 18, to the backing plate 12 by fixing means 178 such as a rivet. The anchor plate 176 serves to position an end portion of each of the brake shoes 14, 16 (which portion is close to the anchor 18,) relative to the backing plate 12. The anchor plate 176 has a pipe holding portion 180 having a surface which is curved along the outer circumferential surface of the guide pipe 146. The pipe holding portion 180 positions the other end portion of the guide pipe 146 relative to the backing plate 12 such that the other end portion of the guide pipe 146 is held between the pipe holding portion 180 and the backing plate 12. The pipe holding portion 180 has an engaging portion in the form of an engaging hole 182 which is formed through the pipe holding portion 180, while the other end portion of the guide pipe 146 has an engaging portion in the form of a locking pawl 184 which projects in a direction away from the backing plate 12 so as to be brought into engagement with the engaging hole 182. The engagement of the locking pawl 184 with the engaging hole 182 prevents displacement of the other end portion of the guide pipe 146 in a longitudinal direction of the guide pipe 146 and other direction substantially parallel to a plane of the backing plate 12, whereby the other end portion of the guide pipe 146 is held in a predetermined posture relative the backing plate 12.

The guide pipe 146 has, in the above-described one of longitudinally opposite end portions, a radial protrusion in the from of an integrally formed annular protrusion 186 which radially outwardly protrudes from the outer circumferential surface of the guide pipe 146. The annular protrusion 186 of the guide pipe 146 is brought into engagement with an edge portion of the backing plate 12 defining the opening 12h, when the other end and intermediate portions of the guide pipe 146 is introduced through the opening 12h from a rear side of the backing plate 12 to a front side of the backing plate 12 on which side the brake shoes 14, 16, the brake lever 34 and the other components are disposed, upon assembling of the drum brake 110. The engagement of the annular protrusion 186 with the edge portion of the backing plate 12 limits a distance over which the guide pipe 146 is introduced into the interior of the drum brake 110, i.e., to the front side of the backing plate 12. This engagement may be considered to define or determine the distance over which the guide pipe 146 is to be introduced into the interior of the drum brake 110 upon assembling of the drum brake 110, wherein the distance is predetermined to have an amount which permits the engagement of the engaging hole 182 with the locking pawl 184. That is, when the guide pipe 146 is inhibited from being further introduced into the interior of the drum brake 110, by the engagement of the annular protrusion 186 with the edge portion of the backing plate 12, the anchor plate 176 is attached to the backing plate 12 by the fixing means 178 so that the locking pawl 184 of the guide pipe 146 is introduced into the engaging hole 182 of the anchor plate 176, for thereby holding the other end portion of the guide pipe 146 in the predetermined posture relative the backing plate 12.

As is clear from the foregoing description, the above-described one of the opposite end portions of the guide pipe 146 is positioned by the opening 12h in a predetermined position relative to the backing plate 12, while the other end portion of the guide pipe 146 is positioned by the anchor plate 176 in a predetermined position relative to the backing plate 12 such that the other end portion of the guide pipe 146 is gripped by and between the anchor plate 176 and the backing plate 12. Thus, the guide pipe 146 is accurately positioned in a predetermined portion of the backing plate 12 and is then easily attached to the predetermined portion of the backing plate 12, by simply fixing the anchor plate 176 to the backing plate 12.

Further, the other end portion of the guide pipe 146 is positioned by the pipe holding portion 180 having the curved surface which is fitted on the outer circumferential surface of the guide pipe 146, while the locking pawl 184 of the guide pipe 146 is brought into engagement with the engaging hole 182 formed in the pipe holding portion 180. This arrangement is effective to reliably prevent displacement of the guide pipe 146 relative to the backing plate 12 at least in the longitudinal direction of the guide pipe 146, so that the other end portion of the guide pipe 146 is accurately positioned in the predetermined position relative to the backing plate 12 and is held in the predetermined posture relative the backing plate 12, thereby making it possible to reliably guide the brake cable 36 toward the engaging portion 38 of the brake lever 34.

In addition, the distance over which the guide pipe 146 to is to be introduced into the interior of the drum brake 110 is defined by the engagement of the annular protrusion 186 with the edge portion of the backing plate 12, so as to have the amount which permits the engagement of the engaging hole 182 with the locking pawl 184. This arrangement is effective to make it easy to position the guide pipe 146 relative to the backing plate 12, thereby facilitating the operation for fixing the guide pipe 146 to the backing plate 12 upon assembling of the drum brake 110..

While the presently preferred embodiments of the present invention have been described above with a certain degree of particularity, by reference to the accompanying drawings, it is to be understood that the invention is not limited to the details of the illustrated embodiments, but may be otherwise embodied.

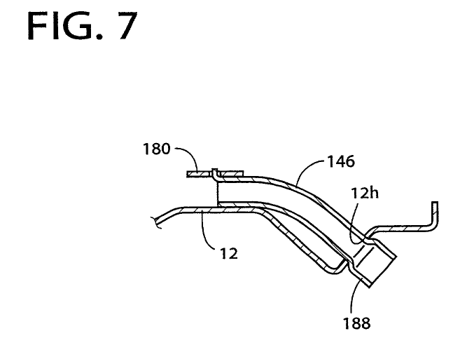

In the above-illustrated second embodiment, the guide pipe 146 has the radial protrusion in the form of the annular protrusion 186, which is spaced apart from an extreme end of the end portion of the guide pipe 146 as viewed in the longitudinal direction of the guide pipe 146. This annular protrusion 186 may be replaced by a large diameter portion 188, which has a predetermined diameter and extends in the longitudinal direction of the guide pipe 146 from the extreme end of the end portion of the guide pipe 146 toward the other end portion of the guide pipe 146 over a predetermined longitudinal distance, as shown in FIG. 7.

In the above-illustrated second embodiment, the pipe holding portion 180 of the anchor plate 176 is provided for holding the other end portion of the guide pipe 146, whereby the other end portion of the guide pipe 146 is fixedly positioned relative to the backing plate 12. However, the guide pipe 146 may be directly fixed at the other end or intermediate portion to the backing plate 12 by spot welding, projection welding or other suitable fixing means.

While the presently preferred embodiments of the present invention has been described above in detail by reference to the accompanying drawings, for illustrative purpose only, it is to be understood that the invention may be embodied with various changes, modifications and improvements, which may occur to those skilled in the art, without departing from the spirit and scope of the invention defined in the following claims.

What is claimed is:

1. A brake cable connector device for a brake device including a brake lever having an engaging portion, and a brake cable which has a cable end fixed at one end thereof and which is connected at said cable end to said engaging portion of said brake lever, and wherein a braking force is generated upon a pivotal movement of said brake lever which takes place when said brake cable is pulled, said brake cable connector device operating to guide said cable end into engagement with said engaging portion of said brake lever when an end portion of said brake cable which has said cable end is introduced into an interior of said brake device upon assembling of said brake device, said brake cable connector device comprising:
a guide member formed separately from said brake lever and fixedly attachable to said brake lever, said guide member being configured such that said cable end is brought into contact with said guide member and guided into engagement with said engaging portion of said brake lever when said end portion of said brake cable is introduced into the interior of said brake device at a predetermined position of said brake device.

2. A brake cable connector device according to claim 1, wherein said brake device is a drum brake type parking brake device including (a) a backing plate in the form of a generally circular disc fixed to a body of a vehicle, (b) two arcuate brake shoes disposed substantially symmetrically with each other along respective circumferential portions of a periphery of said backing plate such that said two brake shoes are movable toward and away from each other, (c) a parking brake lever as said brake lever connected to one of said two brake shoes such that said parking brake lever is pivotable relative to said one of said two brake shoes about an axis substantially perpendicular to a plane of said backing plate, (d) a strut which engages said parking brake lever and the other of said two brake shoes, (e) a brake drum rotating with a wheel of the vehicle, and (f) a parking brake cable as said brake cable connected to said parking brake lever so that when said parking brake cable is pulled, said parking brake lever is pivoted radially inwardly of said backing plate, causing said two brake shoes to be moved away from each other via said strut and forced against an inner circumferential surface of said brake drum, whereby the braking force is applied to the vehicle, and wherein said guide member is fixedly attachable to said parking brake lever as said brake lever.

3. A brake cable connector device according to claim 2, further comprising a guide pipe which extends through said backing plate and which has an inner open end open in the interior of said drum brake type parking brake device, and wherein said guide member attached to said parking brake lever is configured to guide said cable end into engagement with said engaging portion of said parking brake lever when an end portion of said parking brake cable which has said cable end at the extreme end is introduced into said interior through said guide pipe, while said cable end is advanced toward said engaging portion away from said inner open end of said guide pipe.

4. A brake cable connector device according to claim 1, wherein said engaging portion of said brake lever consists of a J-shaped end portion of said brake lever, said J-shaped end portion having a slot through which said end portion of said brake cable extends with said cable end held in engagement with said engaging portion after said cable end has been connected to said J-shaped end portion, said guide member including a guiding portion for guiding said cable end in sliding contact therewith until said cable end has reached and passed an opening of said slot, as said end portion of said brake cable is advanced through said interior of said brake device, while said end portion of said brake cable is flexed by said guiding portion, said guiding portion of said guide member permitting said end portion of said brake cable to be received in said slot through said opening under a resilient force of said brake cable after said cable end has passed said opening.

5. A brake cable connector device according to claim 4, wherein said guide member includes (a) a U-shaped curved portion having a U shape corresponding to a shape of said slot of said J-shaped end portion of said brake lever, said U-shaped curved portion being fitted in said slot in close contact with an inner surface of said slot, such that said U shape is open toward said opening of said slot, and (b) a positioning portion which engages said brake lever to hold said guide member in a predetermined posture.

6. A brake cable connector device according to claim 5, wherein said positioning portion includes a plurality of engaging tabs which engages said brake lever.

7. A brake cable connector device according to claim 5, wherein said positioning portion includes a gripper arm which grips said brake lever.

8. A brake cable connector device according to claim 5, wherein said positioning portion includes a locking pawl which engages a hole formed in said brake lever.

9. A brake cable connector device according to claim 5, wherein said U-shaped curved portion of said guide member includes a pair of side walls defining said slot, and wherein said guiding portion of said guide member includes a first guide extending from one of said pair of side walls which is located on the side of a body of said brake lever, said first guide extending toward said predetermined position of said brake device, so as to guide said cable end to a position right above said opening of said slot, said guiding portion further including a second guide extending from the other of said pair of side walls which is on the side of a distal end of said J-shaped end portion of said brake lever, said second guide guiding said cable end along an end face of said distal end, and extending over a predetermined distance from said J-shaped end portion of said brake lever in a direction of introduction of said end portion of said brake cable into the interior of said brake device.

10. A brake cable connector device according to claim 5, wherein said U-shaped curved portion of said guide member is formed from a spring sheet and is held in close contact with the inner surface of said slot of said J-shaped end portion of said brake lever under an elastic force of said spring sheet, said U-shaped curved portion including a pair of side walls defining said slot, said guide member further including an engaging projection which extends from one of said pair of side walls and which is held in engagement with an engaging recess formed in said J-shaped end portion of said brake lever, under an elastic force of said spring sheet, so as to prevent said guide member from being removed from said brake lever.

11. A brake cable connector device according to claim 4, wherein said guide member further includes an integrally formed stop portion for abutting contact with said cable end after said cable end has passed said opening of said slot by more than a predetermined distance in a direction of introduction of said end portion of said brake cable into the interior of said brake device, with said cable end being guided by said guiding portion, said stop portion preventing said cable end from being further advanced after said cable end has passed said opening by said predetermined distance.

12. A brake cable connector device according to claim 1, wherein said guide member is formed from a single spring sheet, and is held fixed to said engaging portion of said brake lever under an elastic force of said spring sheet.

13. A brake cable connector device for a brake device including a backing plate fixed to a body of a vehicle, a brake lever disposed on one of opposite sides of said backing plate, and a brake cable connected at an end portion thereof to said brake lever, and wherein a braking force is generated upon a pivotal movement of said brake lever which take places when said brake cable is pulled, said brake cable connector device comprising a guide pipe which extends through an opening formed through said backing plate, such that said brake cable is introduced from the other of the opposite sides of said backing plate to said one of the opposite sides of said backing plate through said guide pipe whereby said end portion of the brake cable is guided toward said brake lever upon assembling of said brake device, wherein an improvement comprises:
said guide pipe being introduced through said opening of said backing plate from said other of the opposite sides of said backing plate to said one of the opposite sides of said backing plate, whereby one of opposite end portions of said guide pipe is positioned by said opening in a predetermined position relative to said backing plate; and
said guide pipe having in said one of the opposite end portions a radial protrusion which is brought into engagement with an edge portion of said backing plate defining said opening of said backing plate, for limiting a distance over which said guide pipe is introduced to said one of the opposite sides of said backing plate.

14. A brake cable connector device according to claim 13, wherein said backing plate consists of a generally circular disc, and wherein said brake device is a drum brake type parking brake device further including (a) two arcuate brake shoes disposed substantially symmetrically with each other along respective circumferential portions of a periphery of said backing plate such that said two brake shoes are movable toward and away from each other, (b) a parking brake lever as said brake lever connected to one of said two brake shoes such that said parking brake lever is pivotable relative to said one of said two brake shoes about an axis substantially perpendicular to a plane of said backing plate, (c) a strut which engages said parking brake lever and the other of said two brake shoes, (d) a brake drum rotating with a wheel of the vehicle, and (e) a parking brake cable as said brake cable connected to said parking brake lever so that when said parking brake cable is pulled, said parking brake lever is pivoted radially inwardly of said backing plate, causing said two brake shoes to be moved away from each other via said strut and forced against an inner circumferential surface of said brake drum, whereby the braking force is applied to the vehicle.

15. A brake cable connector device for a brake device including a backing plate fixed to a body of a vehicle, a brake lever disposed on one of opposite sides of said backing plate, and a brake cable connected at en end portion thereof to said brake lever, and wherein a braking force is generated upon a pivotal movement of said brake lever which take places when said brake cable is pulled, said brake cable connector device comprising a guide pipe which extends through an opening formed through said backing plate, such that said brake cable is introduced from the other of the opposite sides of said backing plate to said one of the opposite sides of said backing plate through said guide pipe whereby said end portion of the brake cable is guided toward said brake lever upon assembling of said brake device, wherein an improvement comprises:
one of opposite end portions of said guide pipe being positioned by said opening in a predetermined position relative to said backing plate; and
said brake device further including a holding member which is fixed to said backing plate, and which positions the other of the opposite end portions of said guide pipe in a predetermined position relative to said backing plate such that said other of the opposite end portions of said guide pipe is held between said holding member and said backing plate.

16. A brake cable connector device according to claim 15, wherein said backing plate consists of a generally circular disc, and wherein said brake device is a drum brake type parking brake device further including (a) two arcuate brake shoes disposed substantially symmetrically with each other along respective circumferential portions of a periphery of said backing plate such that said two brake shoes are movable toward and away from each other, (b) a parking brake lever as said brake lever connected to one of said two brake shoes such that said parking brake lever is pivotable relative to said one of said two brake shoes about an axis substantially perpendicular to a plane of said backing plate, (c) a strut which engages said parking brake lever and the other of said two brake shoes, (d) a brake drum rotating with a wheel of the vehicle, and (e) a parking brake cable as said brake cable connected to said parking brake lever so that when said parking brake cable is pulled, said parking brake lever is pivoted radially inwardly of said backing plate, causing said two brake shoes to be moved away from each other via said strut and forced against an inner circumferential surface of said brake drum, whereby the braking force is applied to the vehicle.

17. A brake cable connector device according to claim 15, wherein said guide pipe is introduced through said opening of said backing plate from said other of the opposite sides of said backing plate to said one of the opposite sides of said backing plate, whereby said one of the opposite end portions of said guide pipe is positioned by said opening in the predetermined position relative to said backing plate;
wherein at least one of said backing plate and said holding member has an engaging portion which is brought into engagement with said other of the opposite end portions of said guide pipe, for preventing displacement of said other of the opposite end portions of said guide pipe relative to said backing plate at least in a longitudinal direction of said guide pipe toward said other of the opposite sides of said backing plate away from said one of the opposite sides of said backing plate;
and wherein said guide pipe has in said one of the opposite end portions a radial protrusion which is brought into engagement with an edge portion of said backing plate defining said opening of said backing plate, for limiting a distance over which said guide pipe is introduced to said one of the opposite sides of said backing plate while permitting said engaging portion to engage said other of the opposite end portions of said guide pipe.

18. A brake cable connector device according to claim 17, wherein said brake device further includes brake shoes, an anchor and an anchor plate which is fixed together with said anchor to said backing plate and which positions said brake shoes relative to said backing plate;
wherein said holding member consists of said anchor plate, and has a pipe holding portion which has a curved surface fitted on an outer circumferential surface of said guide pipe and positions the other of the opposite end portions of said guide pipe in the predetermined position relative to said backing plate such that said other of the opposite end portions of said guide pipe is held between said holding member and said backing plate;
and wherein said engaging portion is provided by an engaging hole which is formed in said at least one of said backing plate and said holding member, and said guide pipe has in said other of the opposite end portions at least one engaging projection which is brought into engagement with said engaging hole, for preventing displacement of said other of the opposite end portions of said guide pipe in a direction substantially parallel to a plane of said backing plate.
